(19) United States
(12) Patent Application Publication
(10) Pub. No.: US 2010/0294246 A1
(43) Pub. Date: Nov. 25, 2010

(54) PARALLEL CRANK DRIVE

(75) Inventors: Enno Lohse, Stolberg (DE); Karsten Wittek, Aachen (DE); Christof Tiemann, Cologne (DE); Werner Bick, Wuerselen (DE); Stefan Pischinger, Aachen (DE)

Correspondence Address: GIFFORD, KRASS, SPRINKLE,ANDERSON & CITKOWSKI, P.C, PO BOX 7021, TROY, MI, 48007-7021, US

(73) Assignee: FEV MOTORENTECHNIK GMBH, Aachen (DE)

(21) Appl. No.: 12/811,305

(22) PCT Filed: Dec. 31, 2007
(86) PCT No.: PCT/EP07/11476

§ 371 Date: Jun. 30, 2010

(51) Int. Cl. F02B 75/04; F16H 57/02

(52) U.S. Cl. 123/48 R; 74/606 R

(57) ABSTRACT

The invention relates to a parallel crank drive (10), particularly for an internal combustion engine (11) having variable compression ratio, having: a first and a second clutch body (20, 21) that can each be connected to a first or second shaft (14, 19); —at least one clutch element (22) rotatably supported on both clutch bodies; —a housing (23) encompassing the clutch bodies and clutch elements. The invention further relates to an internal combustion engine having variable compression ratio, having: a pivotally supported crankshaft (14); —drive shaft (19); —parallel crank drive (10) between the crankshaft and drive shaft; —a housing (23) encompassing the parallel crank drive. The invention further relates to a manual transmission, particularly for an internal combustion engine (11) having variable compression ratio, having: an input shaft (19) that can be connected to a pivotally supported crankshaft (14); the parallel crank drive (10) between the crankshaft and input shaft.

### CROSS REFERENCE TO RELATED APPLICATIONS

This application is the U.S. national phase of PCT/EP2007/011476 filed Dec. 31, 2007, the entirety of which is incorporated herein by reference.

### FIELD OF THE INVENTION

The invention pertains to a parallel crank drive, particularly to a parallel crank drive for an internal combustion engine with a variable compression ratio, to an internal combustion engine with a variable compression ratio and to a manual transmission, particularly to a manual transmission for an internal combustion engine with a variable compression ratio.

### BACKGROUND OF THE INVENTION

EP 1 082 548 B1 describes a parallel crank drive that is referred to as a clutch element and designed for an internal combustion engine with a displaceable crankshaft in order to vary the compression ratio, wherein this parallel crank drive features a first and a second clutch body that are referred to as rotary bodies and coupling elements that are referred to as crank elements. The rotary bodies can be respectively connected to a first and a second shaft. The respective crank elements are rotatably supported on both rotary bodies. In this known clutch element, the two rotary bodies are aligned in parallel planes of rotation and can be respectively connected to the mutually assigned shaft ends of the crankshaft and the output shaft. The crankshaft and the output shaft are arranged one behind the other in an axially parallel fashion with an eccentricity, and the crank elements that connect both rotary bodies have a crank radius that corresponds to the eccentricity and are spaced apart from one another in the circumferential direction. The second rotary body that is connected to the output shaft features two partial bodies that are rigidly connected to one another and referred to as disk elements, wherein the first rotary body that is connected to the crank shaft and also realized in a disk-shaped fashion is arranged between said partial bodies. The two disk elements are rigidly connected to one another on their outer edges by means of screws. The crank elements are supported on the first rotary body and the two disk elements of the second rotary body by means of rolling bearings or even sliding bearings. Due to this housing-like design of the second rotary body, the interior space defined by the two disk elements is realized in the form of an oil chamber that is connected to the engine oil circuit. During operation, this space is filled across the entire circumference under the influence of centrifugal force such that oil is supplied through lubricating channels assigned to the individual bearings of the crank elements.

This known parallel crank drive has the disadvantage that the oil remains in the interior space of the second rotary body up to almost the center of the crankshaft and therefore generates correspondingly high friction during the operation.

### SUMMARY OF THE INVENTION

The invention is based on the objective of developing a parallel crank drive that features lower frictional losses.

This objective is attained with a parallel crank drive according to claim 1 or according to claim 9 or according to claim 11. Other embodiments are described in the dependent claims.

The invention proposes a parallel crank drive, particularly for an internal combustion with variable compression ratio, featuring a first and a second clutch body that can be connected to a first and a second shaft, respectively, at least one coupling element that is rotatably supported on both clutch bodies, and a housing that encloses the clutch bodies and the coupling element.

The housing makes it possible, for example, to modify the above-described parallel crank drive according to EP 1 082 548 B1, the full disclosure of which is incorporated herein by reference, in such a way that the known closed, housing-like design of the second clutch body is replaced with an open design. Starting with the known closed, housing-like design, this open design can be achieved in that the first disk element or partial body situated near the second shaft and/or the second disk element or partial body situated near the first shaft features at least one opening. The oil can exit the interior space defined by the two disk elements through this opening. The openings are preferably arranged in the end faces and/or circumferential surfaces of the disk elements. The openings furthermore result in a reduction of the mass and of the moment of inertia of the second clutch body and of the parallel crank drive. In addition, the recessed bores for the clutch elements in the two disk elements can now be realized in the form of through-bores, wherein this represents a significant simplification in comparison with the blind bores provided in known disk elements for tightness reasons. Furthermore, a seal is no longer required between the two disk elements. The housing also makes it possible, for example, to modify the above-described parallel crank drive known from EP 1 082 548 B1 in such a way that the known two-part design of the second clutch body featuring the two disk elements is replaced with a one-part design, in which the second disk element situated near the first shaft is eliminated.

The housing may be realized in any required fashion. For example, it may be formed by a crankcase of the internal combustion engine or a transmission case of a manual transmission. In this case, the parallel crank drive consequently is situated in the interior of the crankcase or transmission case. However, the housing may also be formed by a wall of a crankcase of an internal combustion engine or a wall of a transmission case of a manual transmission and by a cover that is connected to the wall. In this case, it would be possible, for example, to realize the cover integrally with the wall or to screw the cover to the wall.

It would be possible to support the second clutch body on the housing in the region of the first shaft and/or in the region of the second shaft. This may be realized, for example, with the aid of sliding bearings and/or rolling bearings. The bearings preferably consist of single-row or double-row bearings. The two-sided support, i.e., the support in the region of the first shaft and in the region of the second shaft, is preferably utilized if the parallel crank drive is realized in the form of a dual mass flywheel, in which the first and the second clutch body respectively form the primary flywheel mass and the secondary flywheel mass of the dual mass flywheel.

It would be possible to provide a seal relative to the first shaft, preferably with the aid of a rotary shaft seal, and to provide the coupling element with a lifetime grease filling. The rotary shaft seal prevents oil from being admitted into the parallel crank drive from the main bearing of the first shaft that lies closest to the parallel crank drive. The lubrication of the coupling element bearings with such oil is also unnecessary due to the lifetime grease filling. In this case, the housing that encloses the clutch bodies and coupling elements may also be completely eliminated.

It would be possible to provide the housing with at least one oil drain opening. The oil drain opening is preferably connected to an oil pan of an internal combustion engine or to a transmission case of a manual transmission.

The invention furthermore proposes a parallel crank drive, particularly for an internal combustion with variable compression ratio, featuring a first and a second clutch body that can be connected to a first and a second shaft, respectively, at least one coupling element that is rotatably supported on both clutch bodies, and an oil collector that completely encloses the clutch bodies in the circumferential direction.

Analogous to the above-described housing, this oil collector makes it possible, for example, to realize the above-described open design of the second clutch body featuring the two disk elements and the above-described one-part design of the second clutch body, in which the second disk element is eliminated.

The oil collector is preferably sealed relative to the clutch bodies by means of a labyrinth and/or by means of slip rings.

The invention furthermore proposes a parallel crank drive, particularly for an internal combustion engine with variable compression ratio, featuring a first and a second clutch body that can be connected to a first and a second shaft, respectively, at least one coupling element that is rotatably supported on both clutch bodies, and an oil collector that partially encloses the clutch bodies in the circumferential direction, wherein the first and/or the second clutch body feature(s) at least one oil outlet opening, and wherein a closing device for the oil outlet opening is provided and realized in such a way that the oil outlet opening is opened when it sweeps over the oil collector and is otherwise closed.

Analogous to the above-described housing and the above-described oil collector, this oil collector makes it possible to realize, for example, the above-described open design of the second clutch body featuring the two disk elements and the above-described one-part design of the second clutch body, in which the second disk element is eliminated.

The oil collector may be arranged in any required position in the circumferential direction. It is preferably arranged underneath the two clutch bodies. In this case, the oil collector is also able to collect the oil flowing out of the oil outlet opening while the clutch bodies are at a standstill.

Each of the proposed oil collectors may feature at least one oil drain opening. The oil drain opening is preferably connected to an oil pan of an internal combustion engine or to a transmission case of a manual transmission.

In each of the proposed parallel crank drives, at least one oil supply channel may extend up to the coupling element in the first shaft and the first clutch body. The oil supply channel may be connected, for example, to the oil supply for a bearing of the first shaft such that the oil reaches the coupling element and its bearings in the two clutch bodies directly through this oil supply channel.

In each of the proposed parallel crank drives, the first and/or the second clutch body may feature at least one opening. This opening was already described in greater detail above.

In each of the proposed parallel crank drives, the second clutch body may feature a first partial body situated near the first shaft and a second partial body situated near the second shaft that are mounted one on the other with at least one mounting element, wherein this mounting element extends between the surfaces of the partial bodies that face one another and its radial distance from the second shaft is smaller or equal to the radial distance of at least one coupling element from the second shaft, and wherein the first clutch body is arranged between the partial bodies and features at least one opening through which the mounting element protrudes. The two partial bodies may be shaped as required and are preferably realized in a disk-shaped fashion. The second clutch body featuring the two partial bodies is also realized in two parts, wherein this two-part design was already described in greater detail above. In contrast to the above-described two-part design according to EP 1 082 548 B1 in which the two disk elements or partial bodies are rigidly connected to one another at their outer edges with the aid of screws, the two partial bodies of the proposed second clutch body are mounted one on the other at locations that lie farther radially inward with the aid of mounting elements. Consequently, the outside diameter of the proposed partial bodies can be significantly reduced in comparison with these known disk elements such that the mass and the moment of inertia of the second clutch body and of the parallel crank drive are reduced accordingly.

Each of the proposed parallel crank drives may be realized in the form of a flywheel, preferably a dual mass flywheel. The first and the second clutch body preferably form the primary flywheel mass and the secondary flywheel mass of the dual mass flywheel.

The invention furthermore proposes an internal combustion engine with variable compression ratio featuring a pivotably supported crankshaft, an output shaft and one of the proposed parallel crank drives between the crankshaft and the output shaft.

The invention also proposes an internal combustion engine with variable compression ratio featuring a pivotably supported crankshaft, an output shaft, a parallel crank drive between the crankshaft and the output shaft and a housing that encloses the parallel crank drive.

In each of the proposed internal combustion engines, the housing may be formed by a crankcase of the internal combustion engine.

In each of the proposed internal combustion engines, the housing may be formed by a wall of a crankcase of the internal combustion engine and a cover that is connected to the wall. In this case, it would be possible, for example, to realize the cover integrally with the wall or to screw the cover to the wall.

In each of the proposed internal combustion engines, the parallel crank drive may feature a first and a second clutch body that are connected to the crankshaft and the output shaft, respectively, and at least one coupling element that is rotatably supported on both clutch bodies. The crank radius of the coupling element can be, for example, at a right angle to the two shafts.

In each of the proposed internal combustion engines, the parallel crank drive may be realized in the form of a flywheel, preferably a dual mass flywheel.

In each of the proposed internal combustion engines, a flywheel, preferably a dual mass flywheel, may be incorporated between the parallel crank drive and the output shaft.

In each of the proposed internal combustion engines, the housing may feature at least one oil drain opening that is connected to an oil pan of the internal combustion engine.

The invention furthermore proposes a manual transmission, particularly for an internal combustion engine with variable compression ratio, featuring an input shaft that can be connected to a pivotably supported crankshaft and one of the proposed parallel crank drives between the crankshaft and the input shaft.

The invention also proposes a manual transmission, particularly for an internal combustion engine with variable compression ratio, featuring an input shaft that can be connected to a pivotably supported crankshaft, a parallel crank drive between the crankshaft and the input shaft and a housing that encloses the parallel crank drive.

The preceding explanations regarding the proposed parallel crank drives and internal combustion engines also apply accordingly to the proposed manual transmissions.

In each of the proposed manual transmissions, the housing may be formed by a transmission case of the manual transmission.

In each of the proposed manual transmissions, the housing may be formed by a wall of a transmission case of the manual transmission and a cover that is connected to the wall. In this case, the cover may, for example, be realized integrally with the wall or screwed to the wall.

In each of the proposed manual transmissions, the parallel crank drive may feature a first clutch body that can be connected to the crankshaft, a second clutch body that can be connected to the input shaft and at least one coupling element that is rotatably supported on both clutch bodies. The crank radius of the coupling element may be, for example, at a right angle to the shafts.

In each of the proposed manual transmissions, the parallel crank drive may be realized in the form of a flywheel, preferably a dual mass flywheel.

In each of the proposed manual transmissions, a flywheel, preferably a dual mass flywheel, may be incorporated between the crankshaft and the parallel crank drive.

In each of the proposed manual transmissions, a starting clutch may be provided between the crankshaft and the parallel crank drive or between the parallel crank drive and the input shaft.

### BRIEF DESCRIPTION OF THE DRAWINGS

Other advantageous embodiments of the invention are described in greater detail below with reference to the drawings. However, the individual characteristics shown are not restricted to the respective embodiments, but can also be combined with other individual characteristics described above or with individual characteristics of other embodiments such that additional embodiments are formed. The details in the drawings should merely be interpreted in an explanatory, but not in a restrictive sense. Shown are:

FIG. 1, a longitudinal section through a first embodiment of a parallel crank drive for an internal combustion engine with variable compression ratio,

FIG. 2, a longitudinal section through a second embodiment of a parallel crank drive for an internal combustion engine with variable compression ratio,

FIG. 3, a longitudinal section through a third embodiment of a parallel crank drive for an internal combustion engine with variable compression ratio,

FIG. 4, a schematic cross section of FIG. 3,

FIG. 5, a longitudinal section through a fourth embodiment of a parallel crank drive for an internal combustion engine with variable compression ratio, and

FIG. 6, a schematic cross section of FIG. 5.

### DETAILED DESCRIPTION OF THE INVENTION

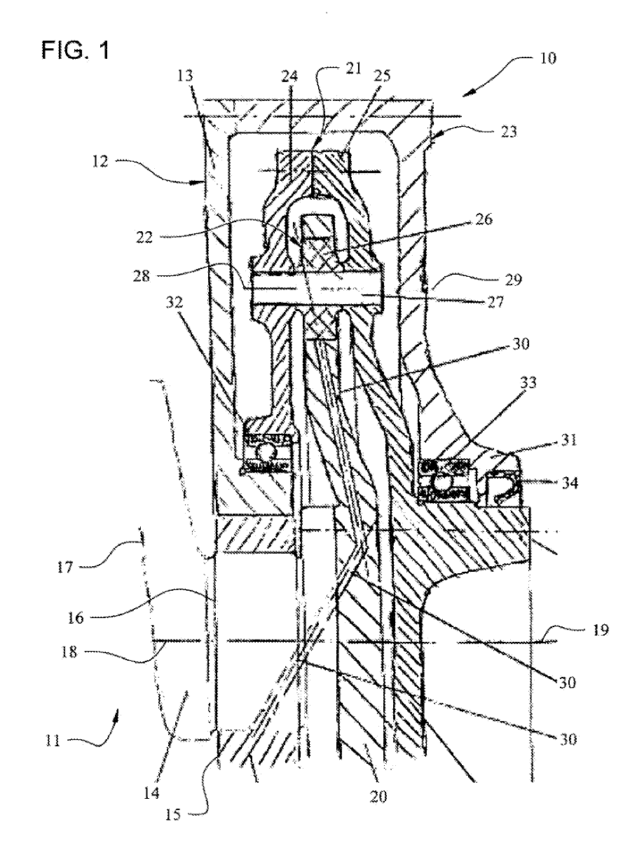

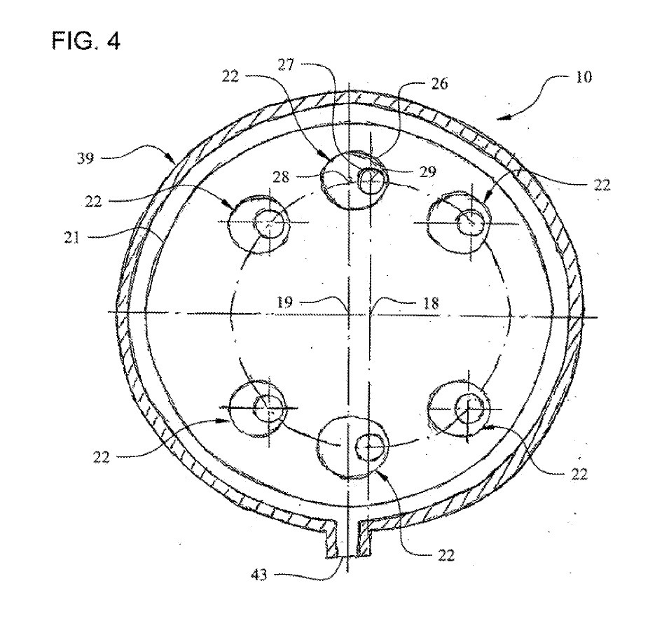

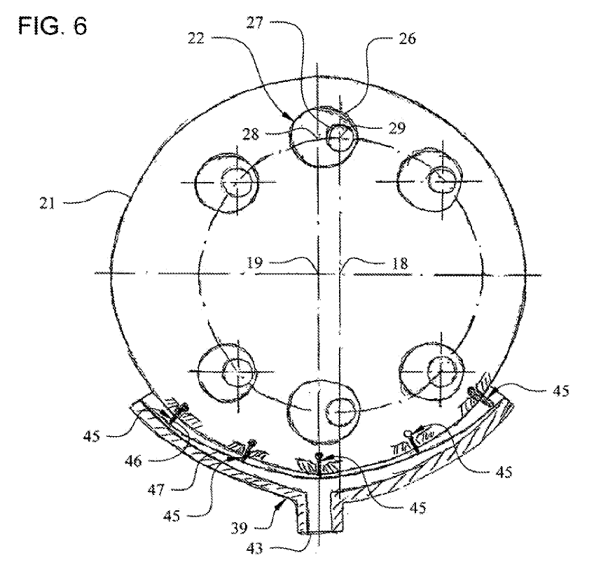

FIG. 1 shows a first embodiment of a parallel crank drive 10 that is, for example, attached to an internal combustion engine 11 with variable compression ratio. The internal combustion engine 11 is only partially illustrated and features a crankcase 12 of which only a wall 13 on the transmission side is shown, a crankshaft 14 and eccentric collars of which only an eccentric collar 15 on the transmission side is shown. The crankshaft 14 that extends farther toward the left in FIG. 1 is merely illustrated in the form of the right end on the transmission side with the shaft journal 16 on the transmission side and the web 17 on the transmission side situated adjacent thereto on the left. The shaft journal 16 is eccentrically supported in the eccentric collar 15 that is supported, in turn, in the wall 13. The other not-shown shaft journals are supported in the other not-shown eccentric collars in the same fashion, and said eccentric collars are supported at not-shown locations in the crankcase 12 in the same fashion. The crankshaft axis 18 defined by the shaft journals 16 can be conventionally pivoted relative to the crankcase 12 about the output shaft axis 19 of a not-shown output shaft that is stationary relative to the crankcase 12 and defined by the eccentric collars 15. Consequently, a detailed description is not provided at this point and we refer, for example, to the explanations in EP 1 082 548 B1 in this context. Although the crankshaft axis 18 and the output shaft axis 19 are not visible in FIGS. 1 to 4 and 5 because they overlap one another in these illustrations, their position is illustrated quite well in FIGS. 4 and 6.

In this case, the parallel crank drive 10 features a first clutch body 20, a second clutch body 21, six coupling elements 22 that are illustrated quite well in FIGS. 4 and 6, but of which only one is visible in FIG. 1, and a housing 23. The first clutch body 20 is realized in a disk-shaped fashion and rigidly connected at a central flange region to a flange of the crankshaft 14 that forms the end of the crankshaft 14 on the transmission side and continues the shaft journal 16 toward the right in FIG. 1. The second clutch body 21 is also realized in a disk-shaped fashion, however, in the form of a hollow disk that is open toward the crankshaft 14, i.e., toward the left in FIG. 1, and in the interior of which the first clutch body 20 is situated. It can be rigidly connected to a flange region of the not-shown output shaft with a central flange region. In this case, the hollow disk shape of the second clutch body 21 is achieved in that it features a first partial body 24 that lies near the crankshaft 14, i.e., on the left in FIG. 1, and is essentially realized in the form of a circular ring and a second partial body 25 that lies near the output shaft, i.e., on the right in FIG. 1, and is essentially realized in a disk-shaped fashion. The outer edges of both partial bodies 24, 25 are axially bent toward one another and connected with the aid of circumferentially distributed screws.

The coupling elements 22 consist of cranks in this case, but may also be realized differently, for example, with the aid of gears. Each coupling element 22 features a cylindrical center disk 26 and a pin 27 that is arranged eccentric and axially parallel thereto, wherein the pin has a smaller diameter than the center disk 26 and protrudes from both end faces of the center disk 26. The center disk axis 28 of the center disk 26 and the pin axis 29 of the pin 27 extend parallel to the crankshaft axis 18 and the output shaft axis 18 and have an eccentricity, i.e., a distance between one another that is identical to the eccentricity of the crankshaft axis 18 and the output shaft axis 19. This is illustrated quite well in FIGS. 4 and 6. The center disk 26 is supported in the first clutch body 20 and the parts of the pin 27 that protrude toward the left and the right from the center disk 26 in FIG. 1 are supported in the first and the second partial body 24, 25. The corresponding bearing bores in the two partial bodies 24, 25 are realized in the form of through-bores in this case. An oil supply channel 30 extends in the crankshaft 14 from the bearing surface of the shaft journal 16 to the end face of the crankshaft flange and then radially outward through the first clutch body 20 via the adjoining end face of its flange part, namely up to the coupling element 22 or, more specifically, up to the center disk 26. Consequently, lubricating oil being supplied to the shaft journal 16 can be routed to the center disk 26 through the oil supply channel 30 and from there to the protruding parts of the pin 27 that are supported in the through-bores. The two partial bodies 24, 25 feature not-shown openings through which the oil emerging from the bearing surfaces of the coupling element 22 can flow out of the interior of the second clutch body 21.

In this case, the housing 23 is formed by the wall 13 and a cover 31 that is connected to the wall 13 with the aid of screws. The second clutch body 21 is supported on the housing 23 in the region of the crankshaft 14 and in the region of the output shaft. For this purpose, the inner edge of the first partial body 24 with the shape of a circular ring is supported radially inward on an axial collar of the wall 13 in the region of the shaft journal 16 with the aid of a first roller bearing 32 and the central flange region of the second partial body 25 is supported radially outward on an inner circumferential surface of a central through-opening of the cover 31 with the aid of a second roller bearing 33. The second clutch body 21 is supported on both sides of the first clutch body 20 and therefore is secured against tilting. A ring seal 34 that prevents oil from leaking out of the housing 23 of the parallel crank drive 10 is provided on the transmission side of the second roller bearing 33 that faces away from the crankshaft 14, i.e., on the right side of the second roller bearing in FIG. 1.

In its not-shown bottom region, the cover 31 features a not-shown oil drain opening that is connected to a not-shown oil pan of the internal combustion engine 11. Consequently, the oil collected by the housing 23 can be routed back to the oil pan through the oil drain opening.

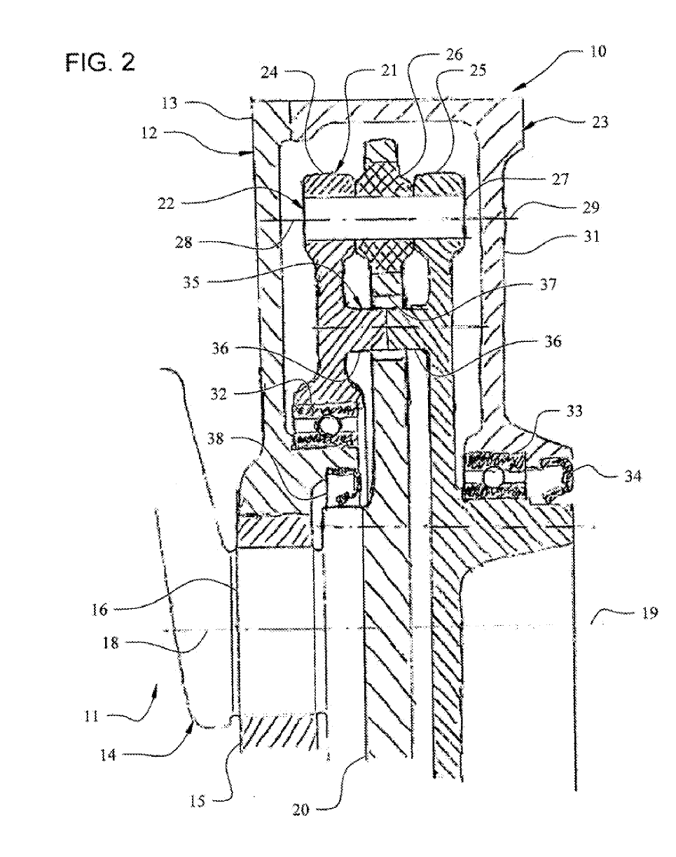

FIG. 2 shows a second embodiment of a parallel crank drive 10 that is realized similar to the first embodiment such that only the differences between the two embodiments are described in detail below. In this second embodiment, the two partial bodies 24, 25 are connected to one another farther radially inward rather than at their outer edges as in the first embodiment. This is achieved with several mounting elements 35, of which only one is illustrated. The radial distances of the mounting elements 35 from the output shaft and the output shaft axis 19 is smaller than the radial distance of the coupling element 22 from the output shaft and the output shaft axis 19 in this case, i.e., the mounting elements 35 lie radially within the coupling elements 22. In addition, the two partial bodies 24, 25 do not extend radially outward any farther than required for the support of the pin 27.

Each mounting element 35 features two mutually aligned elevations 36 that protrude axially inward from the facing inner surfaces of the two partial bodies 24, 25 and are screwed to one another. In the region of each mounting element 35, the first clutch body 20 arranged between the partial bodies 24, 25 features an opening 37 through which the corresponding mounting element 35 protrudes. The openings 37 are shaped such that they do not impair the relative movement between the two clutch bodies 20, 21 during the operation and while the crankshaft 14 is pivoted.

In addition, a second ring seal 38 is provided radially within the first roller bearing 32 between the collar of the wall 13 and the flange of the crankshaft 14 in this second embodiment. This prevents engine oil from leaking out of the crankcase 12 and into the parallel crank drive 10. The oil supply channel 30 of the first embodiment is not provided in this case because the lubrication of the coupling elements 22 is realized differently, e.g., due to the fact that they move through a not-shown oil sump, wherein the oil drain opening that is provided in the first embodiment and that is connected to the oil pan is also eliminated in this case.

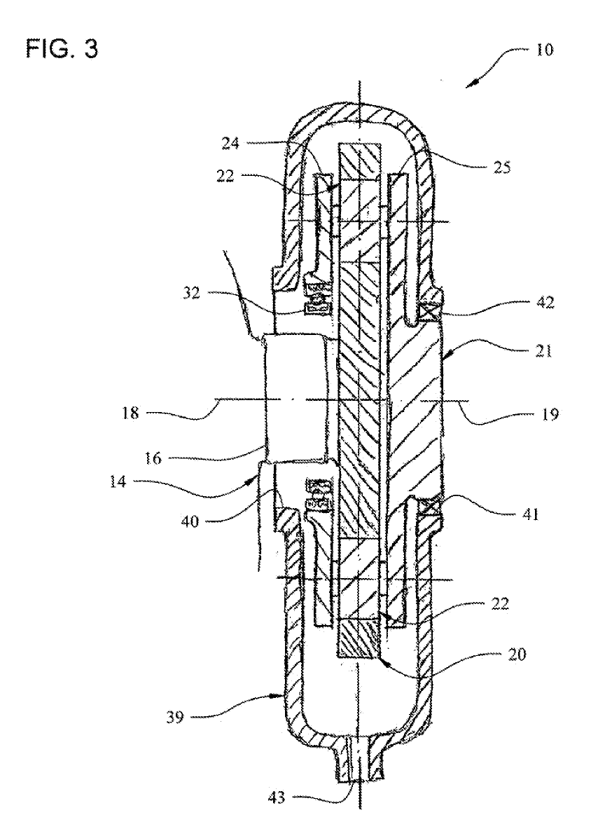

FIGS. 3 and 4 show a third embodiment of a parallel crank drive 10 that is realized similar to the first and the second embodiment such that only the differences between these embodiments are described in detail below. In this third embodiment, an oil collector 39 that completely encloses the clutch bodies 20, 21 in the circumferential direction is provided instead of the housing 23 of the first and second embodiments. In FIG. 3, the wall 13 and the eccentric collar 15 are not illustrated for the sake of clarity. The oil collector features a first and a second central through-opening 40, 41 that are arranged in the lateral surface facing the not-shown crankcase, i.e., in the left lateral surface in FIG. 3, and in the opposite lateral surface, i.e., in the right lateral surface in the figure, respectively. The first through-opening 40 surrounds the not-shown eccentric collar and the shaft journal 16 and is supported on the not-shown collar of the wall 13 with a not-shown slip ring. The second through-opening 41 surrounds the flange of the second coupling body 21 and is supported on this with a slip ring 42. The second roller bearing 33 of the first and the second embodiment is eliminated in this case. The two clutch bodies 20, 21 are realized in the same fashion as in the second embodiment, but may also be realized in accordance with the first embodiment. An oil drain opening 43 is provided on the bottom of the oil collector 39 and connected to the oil pan.

FIG. 4 clearly shows that the oil collector 39 completely encloses the clutch bodies 20, 21 in the circumferential direction.

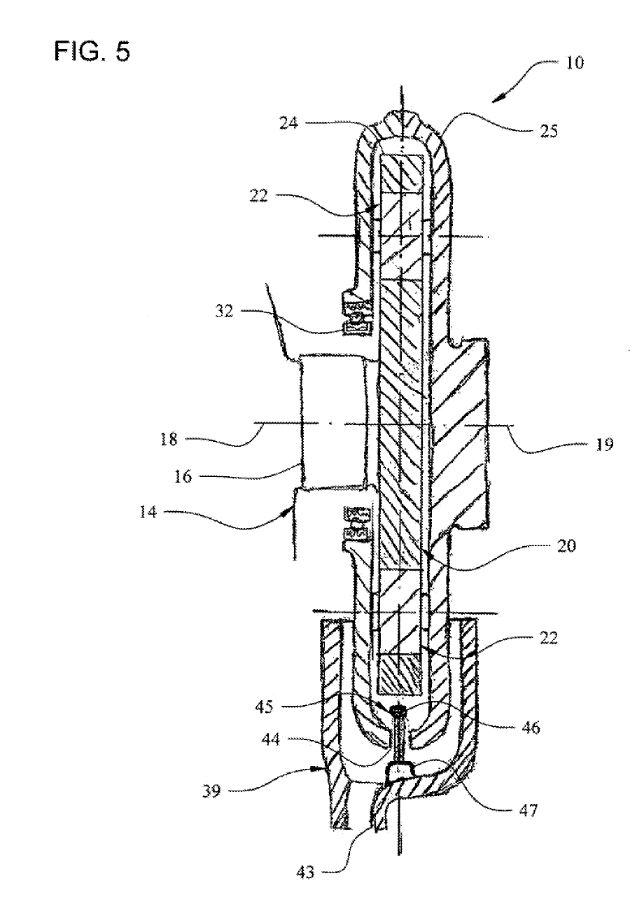

FIGS. 5 and 6 show a fourth embodiment of a parallel crank drive that is realized similar to the third embodiment such that only the differences are described in detail below. In this fourth embodiment, the oil collector 39 does not completely enclose the clutch bodies 20, 21 in the circumferential direction as in the third embodiment, but rather only partially. In this case, it is arranged underneath the two clutch bodies 20, 21 and, in contrast to the third embodiment, its oil drain opening 43 is offset toward the not-shown crankcase 12, i.e., toward the left in FIG. 5.

In this fourth embodiment, the second clutch body 21 furthermore features several openings that are distributed over its circumference and that serve as oil outlet openings 44 for the oil collected in the interior of the second clutch body 21 realized in the form of a hollow disk as in the first embodiment. With respect to these oil outlet openings 44, FIG. 5 only shows the lower oil outlet opening and FIG. 6 only shows the lower five oil outlet openings currently situated in the region of the oil collector 39.

A closing device 45 is provided for each oil outlet opening 44 and realized in such a way that the corresponding oil outlet opening 44 is opened when it sweeps over the oil collector 39 and is otherwise closed. For this purpose, it features a valve pin 46 that cooperates with a ridge 47 protruding radially inward from the bottom of the oil collector 39. The valve pin 46 is seated in the oil outlet opening 44 and its diameter is smaller than that of the oil outlet opening. On the radially inner end, i.e., on the upper end in FIG. 5, it features a spherical shut-off element that can tightly adjoin a correspondingly shaped valve seat around the radially inner edge of the oil outlet opening 44, i.e., the upper edge in FIG. 5, as illustrated quite well on the two outer closing devices 45 in FIG. 6. During the operation, the valve pins 46 are pressed radially outward by the centrifugal force such that the shut-off elements are pressed against their valve seats. In this case, the valve pins 46 protrude relatively far from the oil outlet openings 44 with their radially outer ends, i.e., with their lower ends in FIGS. 5 and 6. However, as soon as a valve pin 46 reaches the region of the oil collector 39, this outer end comes in contact with the upper edge of the ridge 47 that steadily increases in height relative to the bottom of the oil collector 39 radially inward in the circumferential direction from the edge of the oil collector 39 to the center, where the oil drain opening 43 is situated, and then once again decreases in height radially outward up to the opposite edge of the oil collector 39. Consequently, the valve pin 46 is steadily pressed radially inward when it approaches the oil drain opening 43 or the center of the oil collector 39 such that the shut-off element is lifted off its valve seat and the oil can flow radially outward through the now opened oil outlet opening 44 and can be collected by the oil collector 39. The shut-off element is once again lowered onto its valve seat as soon as this closing device 45 moves away from the oil collector 39.

We claim:

1. A parallel crank drive (10) for an internal combustion engine (11) with variable compression ratio, the parallel crank drive (10) comprising:
a first and a second clutch body (20, 21) connected to a first and a second shaft (14, 19), respectively;
at least one coupling element (22) rotatably supported on both the first and the second clutch bodies (20, 21); and
a housing (23) enclosing the first and said second clutch bodies (20, 21) and the at least one coupling element (22).

2. The parallel crank drive according to claim 1, wherein the housing is formed by a crankcase (12) of an internal combustion engine (11) or a transmission case of a manual transmission.

3. The parallel crank drive according to claim 1, wherein the housing (23) is formed by a wall (13) of a crankcase (12) of an internal combustion engine (11) or a wall of a transmission case of a manual transmission and by a cover (31) that is connected to the wall (13) of the crankcase (12).

4. The parallel crank drive according to claim 3, wherein the cover (31) is integral with the wall (13).

5. The parallel crank drive according to claim 3, wherein the cover (31) is screwed to the wall (13).

6. The parallel crank drive according to claim 1, wherein the second clutch body (21) is supported on the housing (23) in the region of the first shaft (14) and/or in the region of the second shaft (19).

7. The parallel crank drive according to claim 1, further comprising:
a rotary shaft seal (38), the rotary shaft seal providing a seal relative to the first shaft (14); wherein
the coupling element (22) features a lifetime grease filling.

8. The parallel crank drive according to claim 1, wherein the housing (23) has at least one oil drain opening (43).

9. A parallel crank drive (10) for an internal combustion engine (11) with variable compression ratio, the parallel crank drive (10) comprising:
a first and a second clutch body (20, 21) connected to a first and a second shaft (14, 19), respectively;
at least one coupling element (22) rotatably supported on both the first and the second clutch bodies (20, 21), and
an oil collector (39) completely enclosing the first and the second clutch bodies (20, 21) in a circumferential direction.

10. The parallel crank drive according to claim 9, wherein the oil collector (39) is sealed relative to the clutch bodies (20, 21) by means of a labyrinth and/or by means of slip rings (42).

11. A parallel crank drive (10) for an internal combustion engine (11) with variable compression ratio, the parallel crank drive (10) comprising:
a first and a second clutch body (20, 21) connected to a first and a second shaft (14, 19), respectively;
at least one coupling element (22) rotatably supported on both the first and the second clutch bodies (20, 21); and
an oil collector (39) partially enclosing the first and the second clutch bodies (20, 21) in a circumferential direction;
wherein the first and/or the second clutch body (20, 21) feature(s) at least one oil outlet opening (44); and
a closing device (45) for the oil outlet opening (44) is opened when it sweeps over the oil collector (39) and is otherwise closed.

12. The parallel crank drive according to claim 11, wherein the oil collector (39) is arranged underneath the both the first and the second clutch bodies (20, 21).

13. The parallel crank drive according to claim 11, wherein the oil collector (39) has at least one oil drain opening (43).

14. The parallel crank drive according to claim 11, wherein at least one oil supply channel (30) extends into the first shaft (14) and the first clutch body (20) up to the coupling element (22).

15. The parallel crank drive according to claim 11, wherein the first and/or the second clutch body (20, 21) has at least one opening (37, 44).

16. The parallel crank drive according to claim 11, wherein:
the second clutch body (21) has a first partial body (24) situated near the first shaft (14) and a second partial body (25) situated near the second shaft (19), the first and the second partial bodies mounted one on each other with at least one mounting element (35), the at least one mounting element extending between surfaces of the first and the second partial bodies that face one another, the at least one mounting element also having a radial distance from the second shaft (19) that is smaller or equal to the radial distance of at least one coupling element (22) from the second shaft (19), and wherein
the first clutch body (20) is arranged between the first and the second partial bodies (24, 25) and features at least one opening (37) through which the mounting element (35) protrudes.

17. The parallel crank drive according to claim 11, wherein the parallel crank drive is in the form of a flywheel.

18. An internal combustion engine (11) with variable compression ratio, the internal combustion engine (11) comprising:
a pivotably supported crankshaft (14);
an output shaft (19); and
a parallel crank drive (10) between the crankshaft (14) and the output shaft (19);
the parallel crank drive (10) having:
a first and a second clutch body (20, 21) connected to a first and a second shaft (14, 19), respectively;
at least one coupling element (22) rotatably supported on both the first and the second clutch bodies (20, 21); and
a housing (23) enclosing the first and said second clutch bodies (20, 21) and the at least one coupling element (22).

19. An internal combustion engine (11) with variable compression ratio, the internal combustion engine (11) comprising:
a pivotably supported crankshaft (14);
an output shaft (19);
a parallel crank drive (10) between the crankshaft (14) and the output shaft (19); and
a housing (23) that encloses the parallel crank drive (10).

20. The internal combustion engine according to claim 19, wherein the housing (23) is formed by a crankcase (12) of the internal combustion engine.

21. The internal combustion engine according to claim 19, wherein the housing (23) is formed by a wall (13) of a crankcase (12) of the internal combustion engine and by a cover (31) that is connected to the wall (13).

22. The internal combustion engine according to claim 21, wherein the cover (31) is integral with the wall (13).

23. The internal combustion engine according to claim 21, wherein the cover (31) is screwed to the wall (13).

24. The internal combustion engine according to claim 19, wherein the parallel crank drive (10) features a first and a second clutch body (20, 21) that can be connected to the crankshaft (14) and the output shaft (19), respectively, and at least one coupling element (22) that is rotatably supported on both the first and the second clutch bodies (20, 21).

25. The internal combustion engine according to claim 19, wherein the parallel crank drive (10) is in the form of a flywheel.

26. The internal combustion engine according to claim 19, wherein a flywheel is incorporated between the parallel crank drive (10) and the output shaft (19).

27. The internal combustion engine according to claim 19, wherein the housing (23) has at least one oil drain opening (43) that is connected to an oil pan of the internal combustion engine.

28. A manual transmission, particularly for an internal combustion engine (11) with variable compression ratio, the manual transmission comprising:
an input shaft (19) connected to a pivotably supported crankshaft (14); and
a parallel crank drive (10) between the crankshaft (14) and the input shaft (19);
the parallel crank drive (10) having:
a first and a second clutch body (20, 21) connected to a first and a second shaft (14, 19), respectively;
at least one coupling element (22) rotatably supported on both the first and the second clutch bodies (20, 21); and
a housing (23) enclosing the first and said second clutch bodies (20, 21) and the at least one coupling element (22).

29. A manual transmission, particularly for an internal combustion engine (11) with variable compression ratio, the manual transmission comprising:
an input shaft (19) connected to a pivotably supported crankshaft (14);
a parallel crank drive (10) between the crankshaft (14) and the input shaft (19); and
a housing (23) that encloses the parallel crank drive (10).

30. The manual transmission according to claim 29, wherein the housing (23) is formed by a transmission case of the manual transmission.

31. The manual transmission according to claim 29, wherein the housing (23) is formed by a wall of a transmission case of the manual transmission and by a cover that is connected to the wall.

32. The manual transmission according to claim 31, wherein the cover is integral with the wall.

33. The manual transmission according to claim 31, wherein the cover is screwed to the wall.

34. The manual transmission according to claim 29, wherein the parallel crank drive (10) features a first clutch body (20) connected to the crankshaft (14), a second clutch body (21) connected to the input shaft (19), and at least one coupling element (22) rotatably supported on both the first and the second clutch bodies (20, 21).

35. The manual transmission according to claim 29, wherein the parallel crank drive (10) is in the form of a flywheel.

36. The manual transmission according to claim 29, wherein a flywheel is incorporated between the crankshaft (14) and the parallel crank drive (10).

37. The manual transmission according to claim 29, wherein a starting clutch is between the crankshaft (14) and the parallel crank drive (10) or between the parallel crank drive (10) and the input shaft (19).
